(19) United States
(12) Patent Application Publication
(10) Pub. No.: US 2012/0220046 A1
(43) Pub. Date: Aug. 30, 2012

(54) Method and apparatus for forming the doped cryo-biology specimen of electron microscope

(76) Inventor: Chih-Yu Chao, Taipei (TW)

(21) Appl. No.: 13/137,712

(22) Filed: Sep. 7, 2011

(30) Foreign Application Priority Data
Feb. 24, 2011 (TW) 100106143

(51) Int. Cl. G01N 1/00; C25B 9/00; B01J 19/08

(52) U.S. Cl. 436/176; 422/186.04; 204/242

(57) ABSTRACT

The invention discloses a method and apparatus for forming the doped cryo-biology specimen of electron microscope. The invention applies rapid cryogenic freezing to the biology specimen, and dopes certain concentration of protons and electrons into the cryo-biology specimen for conducting the observation using electron microscope. The invention reduces the radiation damage of cryogenic biology specimen and amorphous ice caused by the electron radiation, and observes the prototype of biomolecules and biomaterials clearly.

### BACKGROUND OF THE INVENTION

1. Field of the Invention

The invention relates to a method and apparatus for forming the doped cryo-biology specimen, particularly to a method and apparatus for forming the doped cryo-biology specimen of electron microscope.

2. Description of the Prior Art

The electron microscope (EM) was invented in the early years of 20th century. After the continuous development for several decades, it has already become an important and often times indispensable tool in the modern science and technology, and has already been applied in the biotechnology field massively. Compared to 0.1 mm resolution of human bare eyes, the resolution of common optical microscope is 500×, and the resolution of electron microscope is almost 500,000×. Besides the electromagnetic lens system in the main column, the electron microscope has the auxiliary vacuum pumping apparatus and many other electric systems. There is similar principle between the electron microscope and the optical microscope. For example, the electron beam in the electron microscope is focused by the electromagnetic coils. It is similar to the light beam in the optical microscope, which is focused by the optical lens.

Many types of electron microscope have already been developed, wherein the transmission electron microscope (TEM) has already been applied in the biological field extensively. The image of transmission electron microscope comes from the phase contrast of the electron beam transmitting through the protein molecule specimen or the biological cell specimen. Because the protein molecule or the biological cell specimen is made up of lighter elements' mainly, such as carbon, hydrogen, and oxygen, the produced image contrast is not strong enough, therefore the displayed image is not clear.

Even though the present electron microscope and relevant technology can bring the development of biotechnology field into the resolution level of several nanometers, it still cannot solve all problems in the biotechnology field. The electron microscope must cooperate with different electron microscopy technologies in the application of biotechnology field. For example, the newly developed cryo-electron microscopy (Cryo-EM) can be used for the observation of protein structure. In the cryo-electron microscopy, the proteins do not need to be crystallized. Rather, the biological specimens are prepared by rapid freezing the samples. Then, the samples are embedded in amorphous ice to form as observable specimens. Therefore, there are many advantages for the cryo-electron microscopy compared to the conventional X-ray diffraction and nuclear magnetic resonance (NMR) technologies. However, the cryo-electron microscopy is unable to provide the atomic resolution, because the specimen in the cryo-electron microscopy can only tolerate 10 to 20 e/Å² dosage of electron radiation. It means too much electron dosage will damage the biological materials, and the damaged molecule fragments will have slight movements, which will blur the image and will cause the microscope lose the atomic resolution ability, thus the practicability of cryo-electron microscopy is not good enough.

Therefore, in the post genome era of mankind, in order to understand the structure and function of various proteins more, it is necessary to develop the biomolecular electron microscope with the atomic resolution, and promote the development and progress of natural science field by observing the biological materials and proteins etc. through the improvement and advancement of technical tools.

### SUMMARY OF THE INVENTION

The invention relates to a method and apparatus for forming the doped cryo-biology specimen of electron microscope. It is able to dope the proton and the electron into the cryo-biology specimen at the amorphous-ice state, and the biomolecular structure of cryo-biology specimen will not be damaged in the doping process.

The invention relates to a method for doping the proton and the electron into the cryo-biology specimen at the amorphous-ice state. Firstly, freezing the biomolecular aqueous solution rapidly, and making the biomolecular aqueous solution become the cryo-biology specimen at the amorphous-ice state. Then, doping the proton and the electron into the cryo-biology specimen is achieved at the amorphous-ice state under the cryogenic temperature. After doping certain concentration of protons and electrons, the cryo-biology specimen at the amorphous-ice state can be changed into the conductor. The free electrons in the doped cryo-biology specimen can be promptly returned to the protein molecule fragments or water molecular free radicals damaged by the electron beam irradiation. Thus, the radiation damage caused by electron radiation can be repaired quickly by mobile electrons in the doped cryo-biology specimen at any time. The invention can reduce the radiation damage of biomolecules and the surrounding amorphous-ice environment under electron beam exposure. Therefore, the prototype of proteins or biological specimens can be observed clearly.

The invention can break through the key technology of electron microscopy, so as to develop the biomolecular electron microscope with the atomic resolution.

The invention can improve the resolution of electron microscopy at the cost-saving way, and only needs to develop some relevant key technologies to improve the resolution of any electron microscope.

The invention has many important advantages. Due to the fabrication of components is very easy, it is able to observe different proteins, and can be applied to relevant fields, such as the biology, medicine, and biochemistry field etc.

The invention can convert the amorphous ice doped with protons and electrons into the conductor. It can reduce the radiation damage of amorphous-ice biology specimen caused by the electron beam irradiation, and provide enough electron dosage for observing the prototype of biomaterials clearly.

Therefore, the advantage and spirit of the invention can be understood further by the following detail description of invention and attached figures.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a diagram illustrating the specimen grid for the cryo-biology specimen of electron microscope.

FIG. 2 is a diagram illustrating a first preferred embodiment of cryo-biology specimen doping apparatus for use of electron microscope provided by the invention.

FIG. 3 is a diagram illustrating a second preferred embodiment of cryo-biology specimen doping apparatus for use of electron microscope provided by the invention.

FIG. 4A is a diagram illustrating the doping reaction of protons and electrons of the invention.

FIG. 4B is a diagram illustrating the doping reaction of protons and electrons of the invention.

FIG. 5 is a diagram illustrating a third preferred embodiment of cryo-biology specimen doping apparatus for use of electron microscope provided by the invention.

FIG. 6 is a diagram illustrating the magnified interfacial diagram of catalyst electrode particle and electrolyte.

FIG. 7 is a diagram illustrating a fourth preferred embodiment of cryo-biology specimen doping apparatus for use of electron microscope provided by the invention.

FIG. 8A is a diagram illustrating a fifth preferred embodiment of cryo-biology specimen doping apparatus for use of electron microscope provided by the invention.

FIG. 8B is a diagram illustrating the external applied voltage for the fifth preferred embodiment of cryo-biology specimen doping apparatus for use of electron microscope provided by the invention.

### DESCRIPTION OF THE PREFERRED EMBODIMENT

The invention relates to a method for forming the doped cryo-biology specimen of electron microscope, which mainly comprises the following detailed procedures:

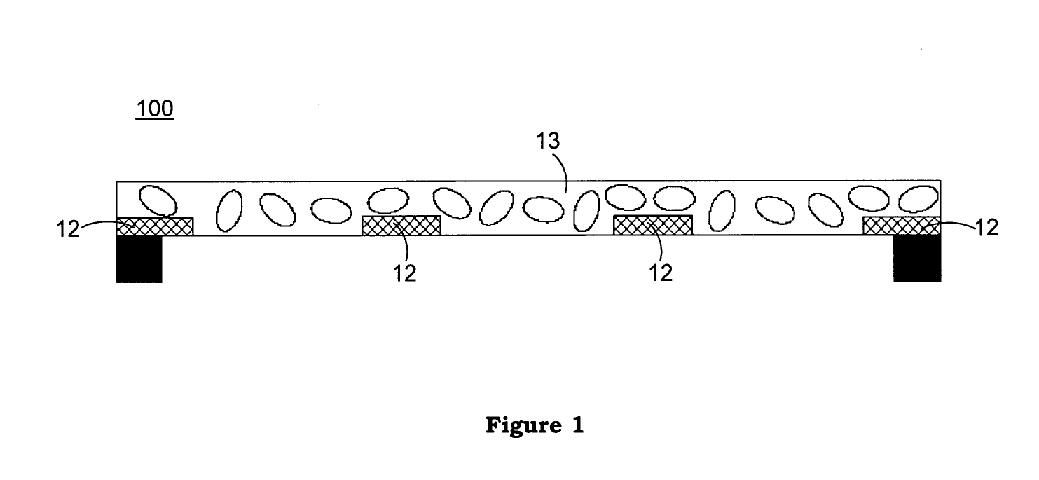

As shown in FIG. 1 firstly, adding a biomolecule into an aqueous solution to become a biomolecular aqueous solution, and then dropping the biomolecular aqueous solution into the specimen grid 100 is carried out. Then, remove the surplus solution with the filter paper. It is rapidly frozen to about 77K by low-temperature liquid ethane, so that the biomolecular aqueous solution becomes the cryo-biology specimen 13 at the amorphous-ice state. Still as shown in FIG. 1, the cryo-biology specimen 13 is frozen and stored in the specimen grid 100. The specimen grid 100 is composed of amorphous carbon film 12 in the shape as holey carbon film. In addition, in order to increase the electric conductivity of electrons in the amorphous ice during the doping process, the biomolecule can be added into the aqueous solution containing sodium phosphate (NaH₂PO₄). It means the biomolecule, such as protein etc., is immersed in the aqueous solution of sodium phosphate electrolyte with suitable concentration, then it is frozen rapidly by liquid ethane. The concentration of sodium phosphate solution is between 100 μM and 150 mM. After the sodium ion and dihydrogen phosphate ion are doped into the aqueous solution, the aqueous solution containing the sodium ions will at least comprise the conduction level close to Fermi level. The conduction level can also be called as the lowest unoccupied molecular orbital (LUMO). In the invention, the ions doped into the aqueous solution, such as sodium ion and dihydrogen phosphate ion (H₂PO₄⁻), or hydrogen carbonate ion (HCO₃⁻) and chlorine ion etc. are not heavy metal elements. Their concentrations should be controlled below about 100 mM, so as not to influence the contrast and resolution of the microscopic image. The thickness of the cryo-biology specimen 13 should be controlled at about 100 nm, in order to prevent the multiple scattering of electron and thus influence the resolution of electron microscope.

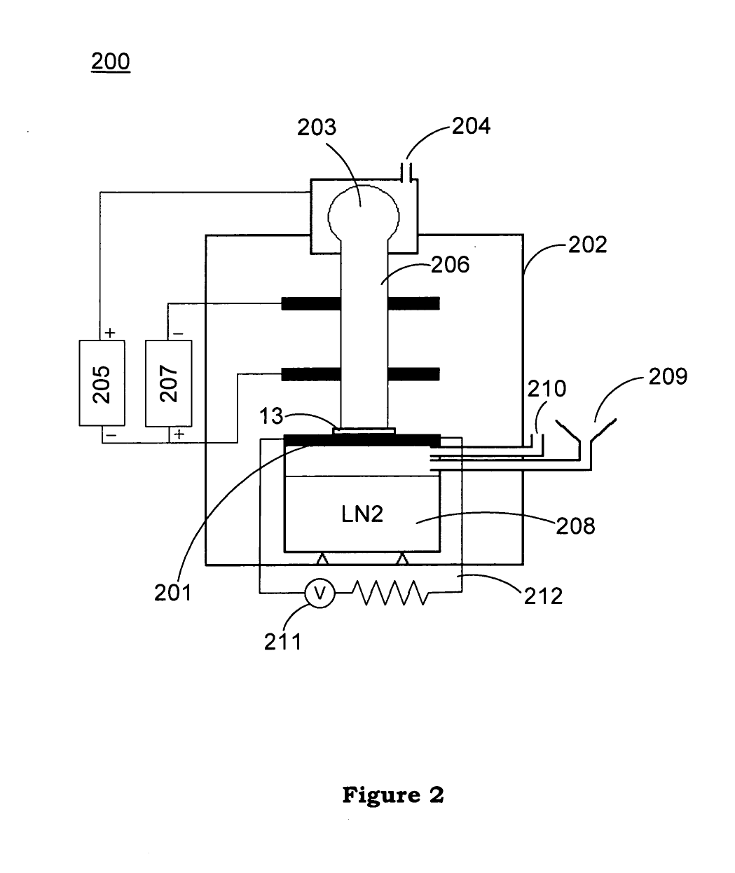

Transfer the cryo-biology specimen 13 to the cryo-biology specimen doping apparatus used for electron microscope shown in FIG. 2. Doping the proton and electron into the cryo-biology specimen 13 is carried out in order to reduce the radiation damage of the cryo-biology specimen 13 irradiated by the electron beam of electron microscope. As noted previously, the proton is a hydrogen ion (H+) as a doping source, and the so-called biomaterial may be the biomolecule, protein, tissue or cell.

As shown in FIG. 2, a first preferred embodiment of cryo-biology specimen doping apparatus 200 for use of electron microscope provided by the invention is illustrated. It includes a cryogenic temperature platform 201, also, the cryogenic temperature platform 201 can keep the cryo-biology specimen 13 under cryogenic temperatures. The apparatus 200 includes the vacuum chamber 202. The vacuum chamber 202 is used to maintain the reaction of doping protons and electrons into the cryo-biology specimen 13 under cryogenic temperatures. In the doping process, the inside of vacuum chamber 202 should be kept at high vacuum environment (10⁻⁶ to 10⁻⁹ torr) or lower (less than 10⁻⁹ torr), in order to proceed the cryogenic doping reaction. The vacuum chamber 202 contains a hydrogen ion (H⁺) source 203. The hydrogen gas can be injected into the hydrogen ion source 203 through the hydrogen gas injection tube 204. The hydrogen ion (H⁺) can be produced by hot electrons generated hydrogen dissociation. A suitable extraction voltage 205 can be applied to extract the hydrogen ion (H⁺) from the hydrogen ion source 203 to form the hydrogen ion beam 206. After the hydrogen ion beam 206 extracted by the extraction voltage 205 is decelerated by the deceleration voltage 207, it is injected and diffused into the cryo-biology specimen 13. It is able to control the kinetic energy of hydrogen ion entering into the cryo-biology specimen 13 by adjusting the deceleration voltage 207. In the actual operation, the kinetic energy of hydrogen ion entering into the cryo-biology specimen 13 should be adjusted to only a few eV or less, in order to prevent the damage of the cryo-biology specimen 13 by the incident ion beam. The cryo-biology specimen 13 should be kept away from the discharging area of hydrogen dissociation. Before doping the proton and electron, the cryo-biology specimen 13 should be transferred to the cryogenic temperature platform 201. During the transfer and installation of the cryo-biology specimen 13, the cryo-biology specimen 13 needs to be immersed in the liquid nitrogen (or cold vapor from liquid nitrogen), or one needs to maintain the cryo-biology specimen 13 at high vacuum environment in order to prevent the formation of frost on the cryo-biology specimen 13. After the cryo-biology specimen 13 is installed, one or several cryogenic boxes can be used as the cold trap to cover the cryo-biology specimen 13 during the doping reaction, in order to prevent the cryo-biology specimen 13 from being contaminated by the pollutants inside the vacuum chamber 202. In the embodiment, the cryogenic temperature platform 201 connects a Dewar bottle 208 directly. The Dewar bottle 208 contains the cryogenic liquefied coolant, in order to keep the cryogenic temperature platform 201 under the cryogenic state. The cryogenic liquefied coolant can be injected into the Dewar bottle 208 from the cryogenic liquefied coolant nozzle 209, in order to keep the cryo-biology specimen 13 on the cryogenic temperature platform 201 at the cryogenic temperatures. The nitrogen vapor is leaked from the vent hole 210. In addition, in order to provide the electron to neutralize the proton in the cryo-biology specimen 13, a voltage source 211 can be installed (namely the electron supply source, this electron supply source is connected to an outer circuit 212, and connected to the specimen grid 100 containing the cryo-biology specimen 13, its function is to provide electrons to neutralize the protons inside the cryo-biology specimen 13). The voltage source 211 is connected to the cryogenic temperature platform 201 by the outer circuit 212. The specimen grid 100 containing the cryo-biology specimen 13 is installed on the cryogenic temperature platform 201. The electron can be conducted to the amorphous carbon film 12 on the specimen grid 100 through the outer circuit 212 and the cryogenic temperature platform 201. Then the electron can enter into the cryo-biology specimen 13 to neutralize the proton in it (namely the voltage source 211 can provide electrons to enter into the cryo-biology specimen 13 and neutralize the protons in it).

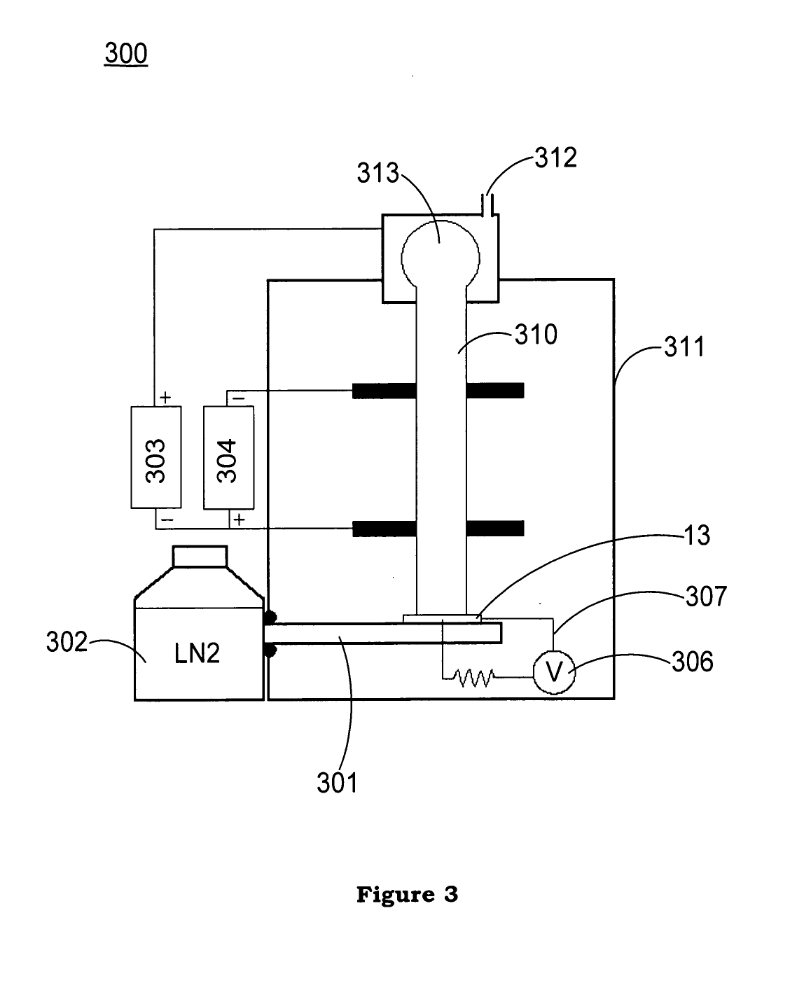

As shown in FIG. 3, a second preferred embodiment of cryo-biology specimen doping apparatus 300 for use of electron microscope provided by the invention is illustrated. The Dewar bottle 302 containing the cryogenic liquefied coolant is connected to the end of the cryogenic temperature platform 301, in order to keep the cryo-biology specimen 13 at the front end of the cryogenic temperature platform 301 under cryogenic temperatures. In addition, in this embodiment, in order to provide the electron to neutralize the proton in the cryo-biology specimen 13, a voltage source 306 (namely the electron supply source) can be installed. The voltage source 306 is connected to the specimen grid 100 containing the cryo-biology specimen 13 by an outer circuit 307. The electron can be conducted to the amorphous carbon film 12 on the specimen grid 100 through the outer circuit 307. Then the electron can enter into the cryo-biology specimen 13 to neutralize the proton in it (namely the voltage source 306 can provide electrons to enter into the cryo-biology specimen 13 and neutralize the protons in it). In this embodiment, it also includes the components, such as the extraction voltage 303, deceleration voltage 304, hydrogen ion beam 310, vacuum chamber 311, hydrogen gas injection tube 312, and hydrogen ion source 313 etc.

Therefore, from the above-mentioned first preferred embodiment and second preferred embodiment of the invention, an apparatus for forming the doped cryo-biology specimen of electron microscope can be revealed. The main components include the cryogenic temperature platform, used for carrying the cryo-biology specimen; the hydrogen ion source, used to extract the hydrogen ion from the hydrogen ion source to form the hydrogen ion beam, and the hydrogen ion beam is injected and diffused into the cryo-biology specimen; and the electron supply source, this electron supply source provides the electron for the doping reaction of the proton and the electron, in order to form the cryo-biology specimen doping apparatus for use of the electron microscope.

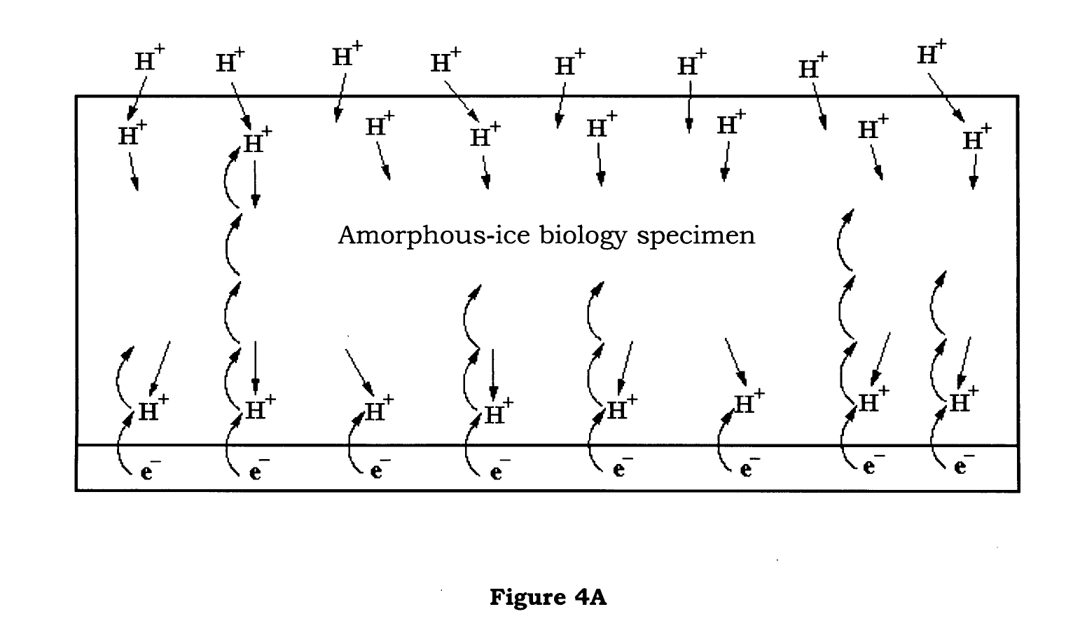

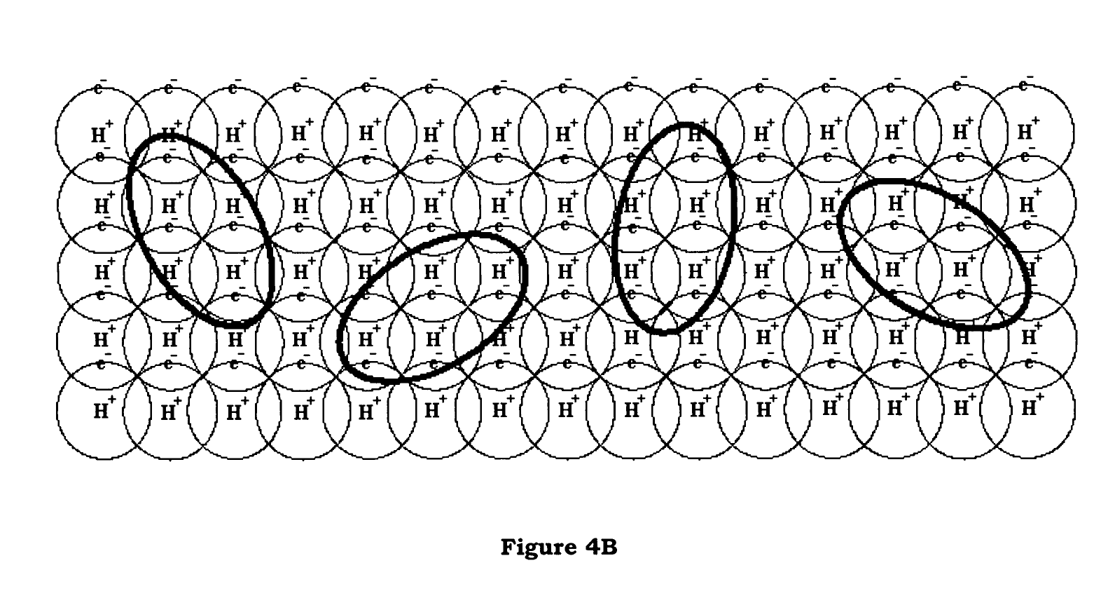

As for the doping reaction of proton and electron, the doping process is shown in FIG. 4A, wherein the OH⁻ ion and protein molecule are not shown in the figure. When the proton is injected and diffused into the cryo-biology specimen, the electron is conducted to the amorphous carbon film on the specimen grid through the outer circuit or the cryogenic temperature platform. As shown in FIG. 4A, the amorphous carbon film is located beneath the amorphous-ice biology specimen. Due to the attraction force between the opposite electric charges, part of protons in the cryo-biology specimen will be attracted to the proximity area of the amorphous carbon film. However it is different from the liquid water that the amorphous ice is solid state. The average distance among the oxygen atoms in the solid-state amorphous ice is 2.85 Å. After 1.2 Å covalent radii of two oxygen atoms (the covalent radius of an oxygen atom is about 0.6 Å) and 0.74 Å covalent radii of two hydrogen atoms (the covalent radius of a hydrogen atom is about 0.37 Å) are subtracted, only average 0.9 Å vacancy among frozen water molecules is left in the amorphous-ice solid. Thus the electron entered into the cryo-biology specimen is unable to reduce the proton to the hydrogen atom, because only 0.9 Å vacancy among frozen water molecules is left in the amorphous ice but the van der Waals diameter of a hydrogen atom is as large as 2.2 Å. Thus, when the electron and proton are collided, the electron needs to be considered in its probability wave nature and will be repelled strongly by the electron clouds of adjacent frozen water molecules, so that the electron is unable to combine with the proton to form hydrogen atom in the solid-state amorphous ice. At this moment, the electron may be localized around the proton or may be adsorbed on water molecule near the proton to form the solvated electron (e⁻_{aq}) localized in the defect of frozen water molecules. Normally the solvated electron is adsorbed by the partially-positive hydrogen atom on water molecule. Due to the vacancy among the frozen water molecules in amorphous-ice solid is very small (only ˜0.9 Å), thus the solvated electron is unable to react with the hydrogen atom on water molecule to form isolated hydrogen atom with 2.2 Å van der Waals diameter under the great repulsion force of the electron clouds of the adjacent frozen water molecules. Because according to Pauli's exclusion principle, there will exist a great repulsion force when the electron clouds overlap, if the hydrogen atom is wanted to be formed in the solid-state amorphous ice, it is necessary to overcome the extremely great repulsion force resulting from the overlap of electron clouds of hydrogen atom and the adjacent frozen water molecules. Thus from the viewpoint of energy, it is actually unable to form the hydrogen atom in the solid-state amorphous ice except for the incident electron energy is high enough.

In this embodiment, in order to increase the electric conductivity of proton and electron in the doping process, the biomolecule can be added into the aqueous solution of sodium phosphate (NaH₂PO₄). It means the biomolecule, such as protein etc., is immersed in the aqueous solution of sodium phosphate electrolyte with suitable concentration, then it is frozen rapidly by liquid ethane. After the sodium ion and dihydrogen phosphate ion are doped into the aqueous solution, the aqueous solution containing the sodium ions will at least comprise the conduction level close to Fermi level.

As shown in FIG. 4A, but the sodium ion and the dihydrogen phosphate ion are not shown in the figure. The protons entering the amorphous ice will be attracted to the proximity area of the amorphous carbon film. The electrons attracted into the amorphous ice by the protons can be conducted to the inside of the amorphous ice through the defects in the amorphous ice and the conduction level formed by periodic sodium ions and the polarized water molecules near the sodium ions. Then, as the doping reaction is proceeded with time, the electrons will enter into the amorphous ice continuously, and the number of solvated electrons localized around the protons and in the defects formed by the protons and frozen water molecules will be increased, so the Fermi level will be raised up. In order to maintain the neutrality inside the amorphous ice, the number of protons injected and diffused into the amorphous ice will also be increased.

As shown in FIG. 4B, the doping reaction of protons and electrons is illustrated. Thus, as the doping reaction is proceeded with time, electrons and protons will be injected into the amorphous ice constantly, high concentration of protons and solvated electrons will be accumulated and stored in the frozen water molecular network of the amorphous ice continuously, wherein the protein molecule is represented by eclipse form shown in FIG. 4B. When the concentration of protons, and electrons inside the amorphous ice reaches more than several M, the electron wavefunction of the solvated electron (as the solid line circle shown in FIG. 4B) will overlap with the adjacent electron wavefunctions. At this moment, the screening from electrons destroys the localized states, and the electrons will move inside the amorphous-ice biological specimen freely in the form of traveling waves. This is the so-called Mott insulator-to-metal transition. Thus, when doping of protons and electrons reaches a certain concentration, the doped cryo-biology specimen will become the conductor under the amorphous-ice state. The free electrons in the doped cryo-biology specimen can be promptly returned to the ionized molecule fragments (or frozen free radicals) to repair the radiation damage of biomolecules caused by electron radiation. Thus, the invention will reduce the radiation damage of the biomolecules and the surrounding amorphous ice under electron beam irradiation.

A method for forming the doped cryo-biology specimen of electron microscope is described above, comprising: carrying out the cryogenic treatment firstly, adding the cryogenic liquefied coolant to the Dewar bottle of the cryo-biology specimen doping apparatus for use of electron microscope. Then the specimen grid containing the cryo-biology specimen is installed on the cryogenic temperature platform of the cryo-biology specimen doping apparatus. Finally, the cryogenic doping reaction of protons and electrons is carried out for the cryo-biology specimen. When the cryogenic doping reaction is completed, the specimen grid containing the doped cryo-biology specimen is transferred and installed on a cryogenic specimen holder. The cryogenic specimen holder is transferred to an electron microscope. Then, the image taking procedure of the electron microscope is carried out.

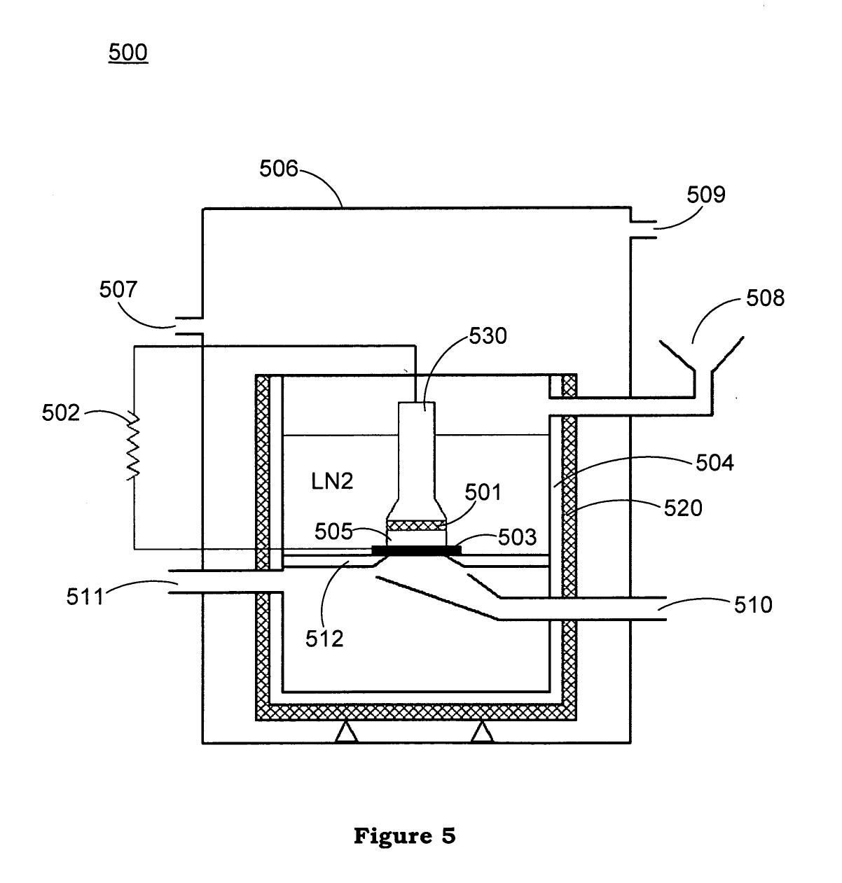

As shown in FIG. 5, a third preferred embodiment of cryo-biology specimen doping apparatus 500 for use of electron microscope provided by the invention is illustrated. The electro-catalytic doping is carried out for the cryo-biology specimen 13 mainly, in order to dope the proton and the electron into this cryo-biology specimen 13. Firstly, the cryo-biology specimen 13 is transferred and installed in the cryo-biology specimen doping apparatus 500. The cryo-biology specimen 13 become an electrode 501 (namely the first electrode) in this apparatus 500. After the first electrode 501 is fixed by a conductive object 530, it is connected to a second electrode 503 through an outer circuit 502. The second electrode 503 is a catalyst electrode 503 for the electro-catalytic reaction, which usually uses the noble metals, such as platinum (Pt), palladium (Pd), rhodium (Rh), and ruthenium (Ru) powders or their alloy powders etc. In this embodiment, the catalyst electrode 503 is the carbon-supported nano-platinum catalyst powders that are closely distributed and fixed in a porous polymer layer (or material) which is then applied onto a porous carbon-fiber material such as carbon paper, carbon cloth, or carbon-fiber plate for practical use. The particle size of nano-platinum catalyst is about 2 nm to 10 nm, which may increase the reaction area and reduce the consumption of noble metal. In addition, the invention even includes the carbon-supported nano-palladium catalyst, carbon-supported nano-rhodium catalyst, and carbon-supported nano-ruthenium catalyst etc. In the process of doping the proton and the electron into the cryo-biology specimen 13, the gas supplied to the catalyst electrode 503 for the electro-catalytic reaction is the hydrogen gas. The hydrogen gas (H₂) is first split into hydrogen atoms and then the hydrogen atom is decomposed into the proton and electron on the catalyst electrode 503. The protons are diffused into the cryo-biology specimen 13 through the electrolyte 505. The electrons are conducted from the catalyst electrode 503 (the second electrode) to the cryo-biology specimen 13 (the first electrode) through an outer circuit 502 under the driving of the electro-catalytic reaction, in order to produce the neutralization reaction with the protons in the cryo-biology specimen 13. In addition, in the process of installing the cryo-biology specimen 13 and doping the proton and the electron into the cryo-biology specimen 13, the cryo-biology specimen 13 should be immersed in the cryogenic liquefied coolant (such as liquid nitrogen or liquid ethane). The cryogenic liquefied coolant should be contained in the cryogenic temperature device 504. The cryogenic temperature device 504 may be covered by a layer of polystyrene to increase the insulation.

In addition, in this embodiment, the electrolyte 505 is the sulfonated tetrafluoroethylene solid-state polymer electrolyte 505—the more well-known name is Nafion. It reveals very high proton conductivity, and its conductivity is about 0.1 S/cm at room temperature. The treated Nafion film has the conductivity comparable to the liquid electrolyte. The sulfonic group (SO₃⁻H⁺) at the side chain of the tetrafluoroethylene polymer can provide the charge sites for the proton transfer effectively.

Still as shown in FIG. 5, the chamber 506 of apparatus 500 may be totally closed or partly closed or even opened chamber. The nitrogen gas from a first gas injection tube 507 can be used to directly blow the surface of liquid nitrogen and the exterior surface of cryogenic temperature device 504 continuously, in order to prevent the formation of frost. The inert gas, such as nitrogen (N₂) or helium (He) etc., may be injected into the first gas injection tube 507, in order to purge out the water vapor in the air, so as to prevent the water molecules from entering into liquid nitrogen to form the movable ice crystals and contaminate the cryo-biology specimen 13. In addition, the injection of inert gas can also prevent other pollutants in air from polluting the liquid nitrogen.

In addition, the liquid nitrogen used in the chamber 506 is contained in a cryogenic temperature device 504 covered with the polystyrene 520 with good insulation ability. In the formation of the doped cryo-biology specimen of electron microscope, it is necessary to supplement the cryogenic liquefied coolant continuously, namely the liquid nitrogen (or the liquid ethane etc.), so that the cryo-biology specimen 13 and the solid-state polymer electrolyte material (such as the solid-state proton exchange film) used as the electrolyte 505 can be immersed in the liquid nitrogen all the time. However, it has to pay attention before the liquid nitrogen from the cryogenic coolant nozzle 508 entering the chamber 506, a filter paper (or a filter) should be used to filter the ice crystals produced by the air moisture in contact with liquid nitrogen. This filter paper can prevent the ice crystals from entering the cryogenic temperature device 504, in order to prevent the contamination of the cryo-biology specimen 13. The nitrogen gas evaporated from the liquid nitrogen surface and the surplus inert gas in chamber 506 can flow out through the vent hole 509. In addition, upon supplementing the liquid nitrogen, the nitrogen gas can be used to purge the cryogenic coolant nozzle 508 continuously to avoid the occurrence of ice crystals to contaminate the liquid nitrogen. Alternatively, the internal automatic supply way can be adopted to directly inject the liquid nitrogen into the cryogenic temperature device 504 inside the chamber 506.

As shown in FIG. 5, the chamber 506 carries the cryogenic temperature device 504. A second gas injection tube 510 (for purging hydrogen gas) and a gas discharge tube 511 are mounted underneath the cryogenic temperature device 504. There is a baffle 512 in the cryogenic temperature device 504. And there is a hole with suitable size near the center of the baffle 512. The second electrode 503 (the carbon-supported nano-platinum catalyst electrode) can be purged by hydrogen gas directly through the hole. The hole may be substituted (or covered) by a grid-like support or a porous thin plate (namely a thin plate having a plurality of porosities) to increase the strength for supporting the second electrode 503. In addition, besides the solid-state polymer electrolyte, the electrolyte may also include the solid-state proton exchange film.

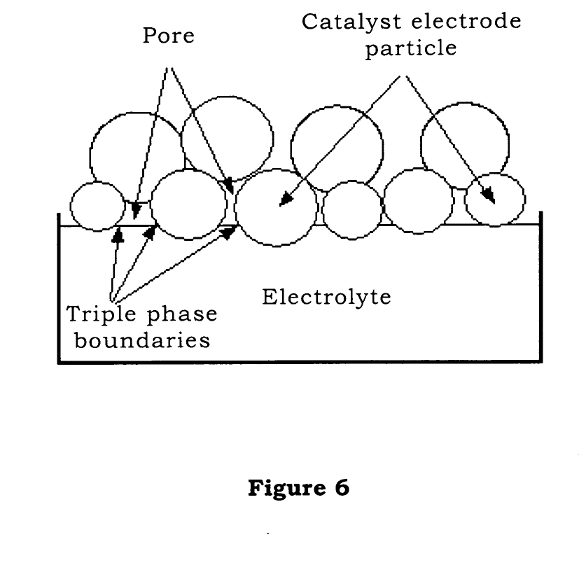

FIG. 6 shows the amplification diagram of platinum catalyst particle (catalyst electrode particle) and electrolyte interface. There are a lot of pores among the platinum catalyst particles, so that the hydrogen gas can diffuse into them for reacting with the platinum particles. When a hydrogen molecule is adsorbed by the platinum, it can be decomposed to two hydrogen atoms. The oxidization reaction of hydrogen atom (the hydrogen atom is oxidized into the proton and electron) can only be taken place at the triple phase boundaries (TPB), namely the closely contacting areas of the electrolyte, hydrogen gas and platinum catalyst particle. In this embodiment, the electrolyte is a cryogenic hydrated Nafion film. Through the interaction of electro-osmosis force, the hydrogen ion (H⁺) can combine with water molecule to form the solvated hydrogen ion (H₃O⁺) and leave the platinum surface. Once the hydrogen ion leaves the platinum surface, the next reaction will be carried on. A new hydrogen molecule can be adsorbed on the platinum surface to produce a series of above-mentioned reactions again. Then, the proton entering Nafion film from the platinum catalyst electrode (anode) will be diffused to the first electrode (cathode) via the concentration gradient and electro-osmosis interaction. Particularly, the proton can form the solvated hydrogen ion (H₃O⁺) easily in the cryogenic hydrated Nafion film and can also be diffused and transferred effectively through the charge sites of sulfonic group (SO₃⁻H⁺), so that the cryogenic hydrated Nafion film still has very high proton conductivity. The electrons accumulated on platinum surface will be conducted to the cathode through the carbon supports around platinum particles and the outer circuit, and produce the neutralization reaction with the protons diffused into the cathode.

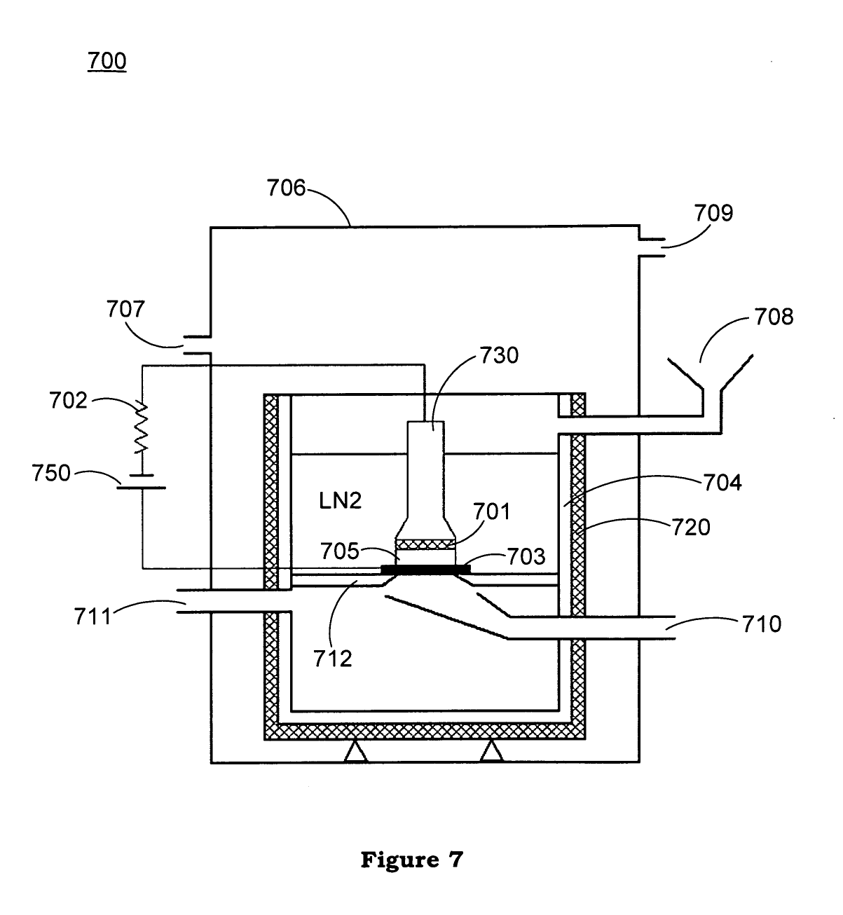

As shown in FIG. 7, a fourth preferred embodiment of cryo-biology specimen doping apparatus 700 for use of electron microscope provided by the invention is illustrated. A voltage source 750 (a battery is provided in this embodiment) is installed in the outer circuit 502 of FIG. 5 mainly. The voltage source 750 can provide the electromotive force to attract the electron on platinum surface. And other components all imitate the components of FIG. 5. Thus, the apparatus in FIG. 7 also includes a cryo-biology specimen doping apparatus 700, a first electrode 701, an outer circuit 702, a second electrode 703 (catalyst electrode), a cryogenic temperature device 704, an electrolyte 705, a chamber 706, a first gas injection tube 707 (for purging nitrogen), a cryogenic coolant nozzle 708, a vent hole 709, a second gas injection tube 710 (for purging hydrogen), a gas discharge tube 711, a baffle 712, a polystyrene 720, a conductive object 730, and a voltage source 750 etc.

As the fourth preferred embodiment shown in FIG. 7, the external bias voltage can be applied to let the hydrogen atom on platinum surface [Pt . . . H] to lose electron easily, and to be oxidized into hydrogen ion [(Pt+e⁻)+H⁺]. The hydrogen ion under applied voltage can easily combine with water molecule to form the solvated hydrogen ion (H₃O⁺) and leave the platinum surface. Once the hydrogen ion leaves the platinum surface, the next reaction will be carried on. The hydrogen ion leaving the platinum surface will enter the cryogenic hydrated Nafion film and diffuse into the first electrode (cathode) under the applied voltage. In the cryogenic environment of this embodiment, the water molecules at the boundary of platinum particles and cryogenic hydrated Nafion film are frozen and thus do not have random degree of freedom, so that the probability for forming the solvated hydrogen ion (H₃O⁺) leaving the platinum surface is relatively lower than that in room temperature. The application of external bias voltage can provide the electromotive force to attract the electron on the platinum surface, in order to overcome the activation energy barrier of electro-catalytic reaction and thus raise the reaction current of electro-catalytic reaction. So, when the external bias is applied in the invention, the reaction current of electro-catalytic reaction can be raised and the reaction time of doping the proton and electron can be reduced.

As for the reaction situation of the cathode, the proton diffuses and enters into the cryo-biology specimen through the Nafion electrolyte. The electron is first conducted to the amorphous carbon film on the specimen grid from the outer circuit. Due to the attraction force between the opposite electric charges, part of protons in the cryo-biology specimen will be attracted to the proximity area of the amorphous carbon film. However, it is different from the liquid water that the amorphous ice is solid state. Thus the electron entered into the cryo-biology specimen is unable to reduce the proton to the hydrogen atom, because only 0.9 Å vacancy among frozen water molecules is left in the amorphous ice but the van der Waals diameter of a hydrogen atom is as large as 2.2 Å. According to Pauli's exclusion principle there exists a great repulsion force when the electron clouds overlap, if the hydrogen atom is wanted to be formed in the solid-state amorphous ice, it is necessary to overcome the extremely great repulsion force resulting from the overlap of electron clouds of hydrogen atom and the adjacent frozen water molecules. Thus, from the viewpoint of energy, it is actually unable to form the hydrogen atom in the solid-state amorphous ice except for the incident electron energy is high enough. At this moment, the electron may be localized around the proton or may be adsorbed on water molecule near the proton to form the solvated electron (e⁻_{aq}) localized in the defect of frozen water molecules. In this embodiment, in order to increase the electric conductivity of proton and electron in the doping process, the biomolecule can be added into the aqueous solution of sodium phosphate (NaH₂PO₄). It means the biomolecule, such as protein etc., is immersed in the aqueous solution of sodium phosphate electrolyte with suitable concentration, then it is frozen rapidly by liquid ethane. Under this situation, the protons entering the amorphous ice will be attracted to the proximity area of the amorphous carbon film. The electrons attracted into the amorphous ice by the protons can be conducted to the inside of the amorphous ice through the defects in the amorphous ice and the conduction level formed by periodic sodium ions and the polarized water molecules near the sodium ions. Thus, as the doping reaction is proceeded with time, the electrons will enter into the amorphous ice continuously, and the number of solvated electrons localized around the protons and in the defects formed by the protons and frozen water molecules will be increased, so the Fermi level will be raised up. In order to maintain the neutrality inside the amorphous ice, the number of protons diffused into the amorphous ice will also be increased.

In addition, as shown in FIG. 7, in order to increase the efficiency for doping the proton and electron in the amorphous ice, a voltage source 750 can be installed in the outer circuit 702 of the cryo-biology specimen doping apparatus 700. This voltage source 750 can overcome the activation energy barrier of electro-catalytic reaction and raise the reaction current of electro-catalytic reaction. A suitable bias can be applied to get higher electric current in the doping process. Thus, as the doping reaction is proceeded with time, electrons and protons will be injected into the amorphous ice constantly, high concentration of protons and solvated electrons will be accumulated and stored in the frozen water molecular network of the amorphous ice continuously, as shown in FIG. 4B. When the concentration of protons and electrons inside the amorphous ice reaches more than several M, the electron wavefunction of the solvated electron (as the solid line circle shown in FIG. 4B) will overlap with the adjacent electron wavefunctions. At this moment, the screening from electrons destroys the localized states, and the electrons will move freely in the amorphous-ice biological specimen in the form of traveling waves. This is the so-called Mott insulator-to-metal transition. When the doping of the proton and electron reaches a certain concentration, the doped cryo-biology specimen will become the conductor under the amorphous-ice state. The free electrons in the doped cryo-biology specimen can be promptly returned to the ionized molecule fragments (or frozen free radicals) to repair the radiation damage of biomolecules by electron radiation. Therefore, the invention can reduce the radiation damage of the biomolecules and the surrounding amorphous ice under electron beam irradiation.

In addition, from the above-mentioned third preferred embodiment and fourth preferred embodiment of the invention, an apparatus for forming the doped cryo-biology specimen of electron microscope can be revealed. The main components include the cryogenic temperature device used for holding the cryo-biology specimen being as the first electrode; the second electrode (catalyst electrode) used for the electro-catalytic reaction; and the electrolyte used for doping the proton and electron under the cryogenic condition, in order to form the cryo-biology specimen doping apparatus for use of electron microscope.

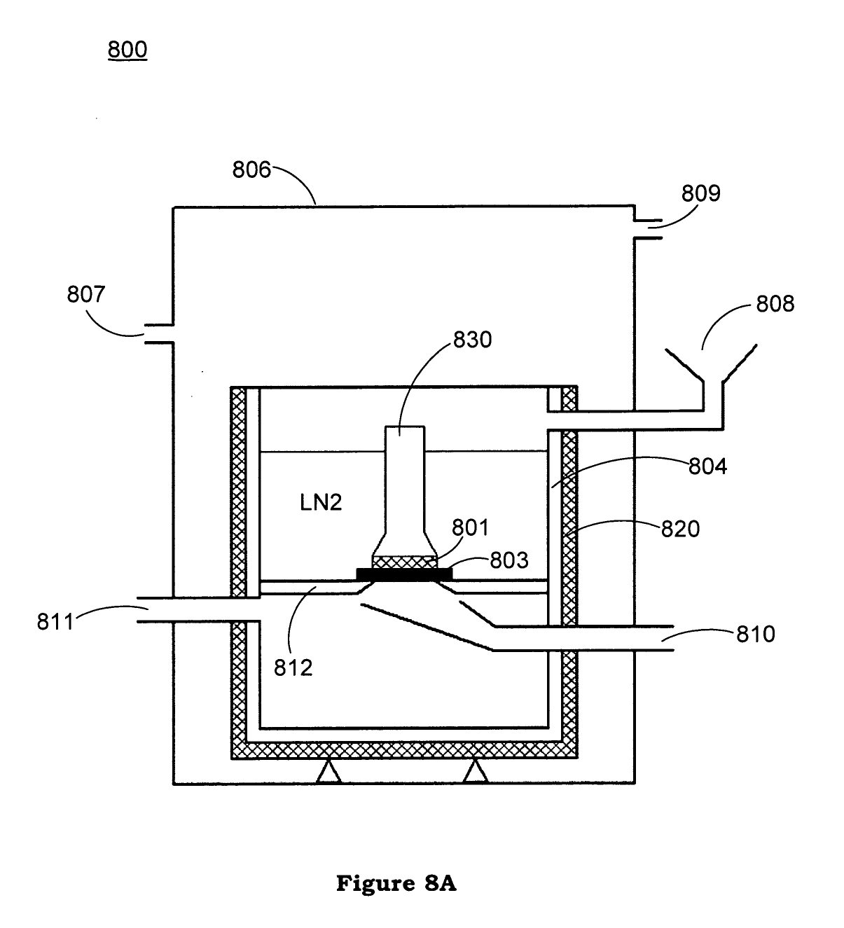

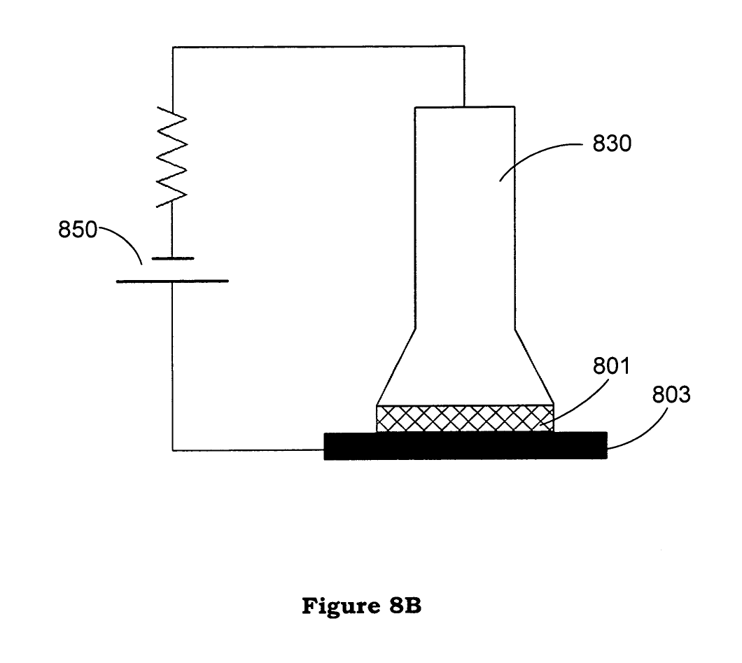

As shown in FIG. 8A, a fifth preferred embodiment of cryo-biology specimen doping apparatus 800 for use of electron microscope provided by the invention is illustrated. The specimen grid 100 is not covered with the cryo-biology specimen 13 completely. Thus, the specimen grid 100 partially containing the cryo-biology specimen 13 (become first electrode 801) can be installed on the catalyst electrode 803 (second electrode 803) for the electro-catalytic reaction, and the outer circuit is not required to connect the cryo-biology specimen 13 and the catalyst electrode 803. The materials used in catalyst electrode 803 is usually noble metals, such as platinum (Pt), palladium (Pd), rhodium (Rh), and ruthenium (Ru) powders or their alloy powders etc. As for the preparation of catalyst electrode, the sputtering, vapor depositing or chemical method can be adopted to grow catalyst electrode nanoparticles on carbon nanotube network film. In this embodiment, the sputtering method is adopted to grow platinum catalyst (namely platinum catalyst nanoparticles) on the carbon nanotube network film. The carbon nanotube network film may be fixed on a flat microporous layer, and then applied onto a porous carbon-fiber material such as carbon paper, carbon cloth, or carbon-fiber plate to increase the strength. In addition, the invention even includes the sputtering growth of palladium catalyst nanoparticles, rhodium catalyst nanoparticles, and ruthenium catalyst nanoparticles etc. In the process of doping the proton and electron into the cryo-biology specimen 13, the gas supplied to the catalyst electrode 803 for the electro-catalytic reaction is the hydrogen gas. The hydrogen gas (H₂) is first split into hydrogen atoms and then the hydrogen atom is decomposed into the proton and electron on the catalyst electrode 803. The protons are diffused into the cryo-biology specimen 13. The electrons under the driving of the electro-catalytic reaction are conducted from the platinum catalyst nanoparticles through carbon nanotube network to the amorphous carbon film of specimen grid 100, and then enter into the cryo-biology specimen 13 to produce the neutralization reaction with the protons inside the cryo-biology specimen 13. In addition, in the process of installing the cryo-biology specimen 13 and doping the proton and electron into the cryo-biology specimen 13, the cryo-biology specimen 13 should be immersed in the cryogenic liquefied coolant (such as liquid nitrogen or liquid ethane). The cryogenic liquefied coolant should be contained in the cryogenic temperature device 804. The cryogenic temperature device 804 may be covered by a layer of polystyrene to increase the insulation.

As shown in FIG. 8A, the chamber 806 of the apparatus 800 carries the cryogenic temperature device 804. A second gas injection tube 810 (hydrogen gas supply source) and a gas discharge tube 811 are mounted underneath the cryogenic temperature device 804. There is a baffle 812 in the cryogenic temperature device 804. And there is a hole with suitable size near the center of the baffle 812. The catalyst electrode 803 (the Pt nanoparticle catalyst electrode) can be purged by hydrogen gas directly through the hole. The hole may be substituted (or covered) by a grid-like support or a porous thin plate (namely a thin plate having a plurality of porosities) to increase the strength for supporting the second electrode 803. In addition, this embodiment also includes a first gas injection tube 807, a cryogenic coolant nozzle 808, a vent hole 809, and fixing object 830.

In addition, as shown in FIG. 8B, in order to increase the efficiency for doping the proton and electron in the cryo-biology specimen, a voltage source 850 can be installed to connect the cryo-biology specimen 13 (the first electrode 801) and catalyst electrode 803. This voltage source 850 can provide the electromotive force to attract the electron on platinum surface. This voltage source 850 can overcome the activation energy barrier of electro-catalytic reaction and raise the reaction current of electro-catalytic reaction. A suitable bias can be applied to get higher electric current in the doping process. Higher concentration of protons and solvated electrons can be injected into the frozen water molecular network of the amorphous ice, as shown in FIG. 4B. When the doping of the proton and electron reaches a certain concentration, the doped cryo-biology specimen will become the conductor under the amorphous-ice state. The free electrons in the doped cryo-biology specimen can be promptly returned to the ionized molecule fragments (or frozen free radicals) to repair the radiation damage of biomolecules and frozen water molecules under electron irradiation. Therefore, the invention can reduce the radiation damage of the biomolecules and the surrounding amorphous ice under electron beam exposure.

From the above-mentioned fifth preferred embodiment of the invention, an apparatus for forming the doped cryo-biology specimen of electron microscope includes the following components: a catalyst electrode used for the electro-catalytic reaction; a hydrogen gas supply source to provide hydrogen gas for carrying on the electro-catalytic reaction with the catalyst electrode; and a cryogenic temperature device used for holding a cryo-biology specimen on the catalyst electrode for a cryogenic doping reaction of a proton and an electron, in order to form the cryo-biology specimen doping apparatus for use of electron microscope.

A method for forming the doped cryo-biology specimen of electron microscope is described above, comprising: carrying on the cryogenic treatment first, adding the cryogenic liquefied coolant to the cryogenic temperature device of the cryo-biology specimen doping apparatus for use of electron microscope. Then the specimen grid containing the cryo-biology specimen is immersed in the cryogenic liquefied coolant, and installed in the cryo-biology specimen doping apparatus. Finally, the cryogenic doping reaction of the proton and electron is carried on for the cryo-biology specimen. When the cryogenic doping reaction is completed, the specimen grid containing the doped cryo-biology specimen is transferred and installed on a cryogenic specimen holder. The cryogenic specimen holder is transferred to an electron microscope. Then, the image taking procedure of the electron microscope is carried out.

When the specimen is observed under the electron microscope, if 4 k×4 k charge-coupled device (CCD) is used and the nominal magnification is up to 100,000×, the image resolution can be up to about 1 angstrom per pixel. Thus it has enough resolution to match with atomic model, which can become the biomolecular electron microscope with atomic resolution directly.

In addition, as for the repair mechanism of radiation damage, because the phonon relaxation time of solid-state amorphous-ice biology specimen is about 10⁻¹⁰ second, the ionized protein fragments and the water molecule free radicals caused by electron radiation will have slight displacement or motion after 10⁻¹⁰ second. Though the time of the occurrence of atomic and molecular displacements can be delayed when biological specimen is kept at the cryogenic temperatures, the permanent radiation damage caused by the electron irradiation cannot be scavenged thoroughly. Thus, only when the amorphous-ice biological specimen becomes the conductor and its electron mobility is close to that of the conductor, the electrons can be promptly returned to ionized protein fragments and water free radicals before the phonon relaxation takes place to repair the radiation damage in the frozen biological specimen. The reason is after the amorphous-ice biological specimen becomes the conductor, the migration speed of free electrons is much faster than 10⁻¹⁰ second of phonon relaxation time. In the invention, when the concentration of the doped protons and electrons inside the amorphous ice reaches more than several M, the so-called Mott insulator-to-metal transition will be occurred. At this moment, the electron wavefunction of the solvated electrons overlaps with the adjacent electron wavefunctions, and thus the electrons can move freely in the amorphous-ice biological specimen in the form of traveling waves. When the doping of the proton and electron reaches a certain concentration, the doped cryo-biology specimen will become the conductor under the amorphous-ice state. The free electrons in the doped cryo-biology specimen can be promptly returned to the ionized molecule fragments (or frozen free radicals) to repair the radiation damage of biomolecules and frozen water molecules under electron irradiation. So, the invention can reduce the radiation damage of the biomolecules and the surrounding amorphous ice under electron beam exposure. In addition, it should be noted that the hydrogen atom could be formed in some larger defects in the amorphous ice. Under the exposure of high dosage electron radiation, the hydrogen atom may be excited and decomposed into the proton and electron, forming a Rydberg-like atom. At this moment, the extent of the spread of the electron wavefunction still has certain size, thus the electrons can also be promptly returned to the ionized molecule fragments (or frozen free radicals) to repair the radiation damage of biomolecules and frozen water molecules within the extent of the electron wavefunction under electron beam irradiation. The decomposed protons can freely migrate and have chance to combine with the negatively charged molecular fragments to scavenge the radiation damage, and thus can help to stabilize the frozen water molecular network of amorphous ice.

The invention applies rapid cryogenic freezing to the biomolecular aqueous solution first, to make the biomolecular aqueous solution becoming the cryo-biology specimen at amorphous-ice state. Then, doping the proton and the electron into the cryo-biology specimen is achieved at the amorphous-ice state under cryogenic temperatures. After doping certain concentration of protons and electrons, the cryo-biology specimen at the amorphous-ice state can be changed into the conductor. The free electrons in the doped cryo-biology specimen can be promptly returned to the protein molecule fragments or water molecular free radicals damaged by the electron beam irradiation. Thus, the radiation damage caused by electron radiation can be repaired quickly by mobile electrons in the doped cryo-biology specimen at any time. The invention can reduce the radiation damage of biomolecules and the surrounding amorphous-ice environment under electron beam exposure. In other words, the invention can raise the electron dosage tolerance of biomolecule, and can improve the resolving ability of electron microscope on the biomolecule to near atomic resolution effectively. Meanwhile, the doping method of this invention will not damage the biomolecular structure of cryo-biology specimen.

It is understood that various other modifications will be apparent to and can be readily made by those skilled in the art without departing from the scope and spirit of the invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to which the invention pertains.

What is claimed is:

1. A method for forming a doped cryo-biology specimen of an electron microscope, comprising:
adding a biomolecule into an aqueous solution to become a biomolecular aqueous solution;
fast freezing the biomolecular aqueous solution to form a cryo-biology specimen; and
doping a proton and an electron into the cryo-biology specimen at a cryogenic temperature in order to form the doped cryo-biology specimen of the electron microscope.

2. The method according to claim 1, wherein the aqueous solution comprises a sodium ion.

3. The method according to claim 1, wherein the fast freezing comprises the fast freezing by a low-temperature liquid ethane.

4. An apparatus for forming a doped cryo-biology specimen of an electron microscope, comprising:
a cryogenic temperature platform means for carrying a cryo-biology specimen;
a hydrogen ion source means for providing a hydrogen ion beam into the cryo-biology specimen; and
an electron supply source means for providing an electron for doping a proton in a cryogenic doping reaction of the proton and the electron in order to form the apparatus for forming the doped cryo-biology specimen of the electron microscope.

5. The apparatus according to claim 4, wherein the cryogenic temperature platform connects Dewar bottle, the Dewar bottle contains a cryogenic liquefied coolant in order to keep the cryogenic temperature platform under a cryogenic state.

6. The apparatus according to claim 4, wherein the apparatus comprises a vacuum chamber, the vacuum chamber is used to maintain the cryogenic doping reaction of the proton and the electron under a cryogenic temperature.

7. The apparatus according to claim 4, wherein the apparatus comprises an extraction voltage being applied to extract a hydrogen ion from the hydrogen ion source to form the hydrogen ion beam.

8. The apparatus according to claim 4, wherein the apparatus having a deceleration voltage means for controlling a kinetic energy of the hydrogen ion entering into the cryo-biology specimen.

9. The apparatus according to claim 4, wherein the electron supply source means for a voltage source connected to an outer circuit, and connected to a specimen grid having the cryo-biology specimen.

10. An apparatus for forming a doped cryo-biology specimen of an electron microscope, comprising:
a cryogenic temperature device means for holding a cryo-biology specimen;
a second electrode being a catalyst electrode for an electro-catalytic reaction; and
an electrolyte means for achieving a cryogenic doping reaction of a proton and an electron in order to form the apparatus for forming the doped cryo-biology specimen of the electron microscope.

11. The apparatus according to claim 10, wherein the cryo-biology specimen doping apparatus of the electron microscope further comprises a chamber.

12. The apparatus according to claim 10, wherein the cryo-biology specimen installed in the cryogenic temperature device becomes a first electrode.

13. The apparatus according to claim 10, wherein the cryogenic temperature device comprises a cryogenic liquefied coolant in order to keep the cryo-biology specimen under a cryogenic state.

14. The apparatus according to claim 10, wherein a material of second electrode is selected from the group consisting of platinum, palladium, rhodium, and ruthenium and their alloys.

15. The apparatus according to claim 10, wherein a material of second electrode is selected from the group consisting of carbon-supported nano-platinum catalyst, carbon-supported nano-palladium catalyst, carbon-supported nano-rhodium catalyst, and carbon-supported nano-ruthenium catalyst.

16. The apparatus according to claim 10, wherein the electrolyte is selected from the group consisting of solid-state polymer electrolyte and solid-state proton exchange film.

17. The apparatus according to claim 10, wherein the apparatus further comprises a voltage source installed in an outer circuit, and the outer circuit connecting the first electrode and the second electrode.

18. An apparatus for forming a doped cryo-biology specimen of an electron microscope, comprising:
a catalyst electrode for carrying out an electro-catalytic reaction;
a hydrogen gas supply source means for providing a hydrogen gas for carrying out the electro-catalytic reaction with the catalyst electrode; and
a cryogenic temperature device means for holding a cryo-biology specimen on the catalyst electrode for a cryogenic doping reaction of a proton and an electron in order to form the apparatus for forming the doped cryo-biology specimen of the electron microscope.

19. The apparatus according to claim 18, wherein the cryo-biology specimen doping apparatus of the electron microscope further comprises a chamber.

20. The apparatus according to claim 18, wherein the cryogenic temperature device contains a cryogenic liquefied coolant in order to keep the cryo-biology specimen under a cryogenic state.

21. The apparatus according to claim 18, wherein a material of catalyst electrode is selected from the group consisting of platinum, palladium, rhodium, and ruthenium and their alloys.

22. The apparatus according to claim 18, wherein a material of catalyst electrode is selected from the group consisting of platinum catalyst nanoparticles, palladium catalyst nanoparticles, rhodium catalyst nanoparticles, and ruthenium catalyst nanoparticles.

23. The apparatus according to claim 18, wherein the apparatus comprises a voltage source connecting the cryo-biology specimen and the catalyst electrode.
